(19) United States
(12) Patent Application Publication
(10) Pub. No.: US 2026/0140626 A1
(43) Pub. Date: May 21, 2026

(54) DATA PROCESSING

(71) Applicant: Tencent Technology (Shenzhen) Company Limited, Shenzhen (CN)

(72) Inventor: Quan LIU, Shenzhen (CN)

(73) Assignee: Tencent Technology (Shenzhen) Company Limited, Shenzhen, GD (CN)

(21) Appl. No.: 19/452,197

(22) Filed: Jan. 16, 2026

Related U.S. Application Data
(63) Continuation of application No. PCT/CN2024/117704, filed on Sep. 9, 2024.

(30) Foreign Application Priority Data
Sep. 11, 2023 (CN) 202311166312.5

(51) Int. Cl. G06F 3/06

(52) U.S. Cl. CPC G06F 3/0608; G06F 3/0604; G06F 3/062; G06F 3/0643; G06F 3/067

(57) ABSTRACT

In a method for processing data, a plurality of data items is acquired from a first data server. The plurality of data items includes keys and data values corresponding to the keys. At least one object data file is generated based on the plurality of data items. The at least one object data file includes the plurality of data items and storage position information of the plurality of data items in a second data server. The at least one object data file is stored on the second data server. The data values corresponding to the keys of the plurality of data items in the first data server are updated with position values indicating the storage position information of the plurality of data items in a second data server.

### RELATED APPLICATIONS

The present application is a continuation of International Application No. PCT/CN 2024/117704, filed on Sep. 9, 2024, which claims priority of Chinese Patent Application No. 202311166312.5 filed on Sep. 11, 2023. The entire disclosures of the prior applications are hereby incorporated by reference.

### FIELD OF THE TECHNOLOGY

This disclosure relates to a data processing technology, including a method and apparatus for processing data, a storage system, a computer-readable storage medium, and a computer program product.

### BACKGROUND OF THE DISCLOSURE

Distributed storage systems are to store data across a plurality of independent data servers to form a plurality of copies of data, so as to achieve high reliability of data and high availability of the system. Over time, the popularity of data access will gradually decrease. The storage system marks data with a low access frequency as cold data and data with a high access frequency as hot data. For cost reasons, industry vendors often store the cold data in low-cost hardware media that do not need to meet high throughput, such as local hard drives, inexpensive clouds that provide block storage or object storage. In contrast, the hot data is often stored in hardware media that provide high throughput and are more costly, such as solid-state drives and non-volatile memory. The process of separating and storing data from hot data media to cold data media is referred to as data cooling. In related technologies, a bypass cooling module can be utilized to scan and filter the data, write the filtered cold data to a less expensive cold storage medium, and delete the cold data in a more expensive hot medium. However, the bypass cooling method requires additional resources to support the bypass cooling module, which will cause the cooling module to become a performance bottleneck, and this method will cause a large number of empty reads in cold data read, reducing the data read efficiency.

### SUMMARY

Embodiments of this disclosure provide a method and apparatus for processing data, a storage system, a computer-readable storage medium, and a computer program product, which can reduce the storage cost of data on the premise of ensuring availability and data reliability.

Embodiments of this disclosure are illustrated as follows.

An embodiment of this disclosure provides a method for processing data. In the method, a plurality of data items is acquired from a first data server. The plurality of data items includes keys and data values corresponding to the keys. At least one object data file is generated by processing circuitry based on the plurality of data items. The at least one object data file includes the plurality of data items and storage position information of the plurality of data items in a second data server. The second data server is configured to store data with an access frequency less than a preset frequency threshold and a degree-of-importance value less than a preset degree-of-importance threshold. The at least one object data file is stored on the second data server. The data values corresponding to the keys of the plurality of data items in the first data server are updated, by the processing circuitry, with position values indicating the storage position information of the plurality of data items in a second data server.

An embodiment of this disclosure provides a data processing apparatus. The data processing apparatus includes processing circuitry configured to acquire, from a first data server, a plurality of data items. The plurality of data items includes keys and data values corresponding to the keys. The processing circuitry is configured to generate at least one object data file based on the plurality of data items. The at least one object data file includes the plurality of data items and storage position information of the plurality of data items in a second data server. The second data server is configured to store data with an access frequency less than a preset frequency threshold and a degree-of-importance value less than a preset degree-of-importance threshold. The processing circuitry is configured to store the at least one object data file on the second data server. The processing circuitry is configured to update the data values corresponding to the keys of the plurality of data items in the first data server with position values indicating the storage position information of the plurality of data items in a second data server.

An embodiment of this disclosure provides a non-transitory computer-readable storage medium storing instructions. The stored instructions, which when executed by a processor, cause the processor to acquire, from a first data server, a plurality of data items. The plurality of data items includes keys and data values corresponding to the keys. The stored instructions, which when executed by the processor, cause the processor to generate at least one object data file based on the plurality of data items. The at least one object data file includes the plurality of data items and storage position information of the plurality of data items in a second data server. The second data server is configured to store data with an access frequency less than a preset frequency threshold and a degree-of-importance value less than a preset degree-of-importance threshold. The stored instructions, which when executed by the processor, cause the processor to store the at least one object data file on the second data server. The stored instructions, which when executed by the processor, cause the processor to update the data values corresponding to the keys of the plurality of data items in the first data server with position values indicating the storage position information of the plurality of data items in a second data server.

An embodiment of this disclosure provides a method for processing data, applied to a storage system which at least includes a first data server and a second data server, the method including: acquiring, from the first data server, a plurality of pieces of data to be processed, the data to be processed including keys to be processed and data values to be processed corresponding to the keys to be processed; generating at least one object data file based on the plurality of pieces of data to be processed, the object data file at least including the data to be processed and storage position information of the data to be processed in the second data server, and the second data server being configured to store data with an access frequency lower than a preset frequency threshold and a degree-of-importance value smaller than a preset degree-of-importance threshold; storing the at least one object data file to the second data server; and updating the data values to be processed corresponding to the keys to be processed in the first data server to position values corresponding to the storage position information.

An embodiment of this disclosure provides an apparatus for processing data, which includes: a first acquisition module, configured to acquire, from a first data server, a plurality of pieces of data to be processed, the data to be processed including keys to be processed and data values to be processed corresponding to the keys to be processed; a file generation module, configured to generate at least one object data file based on the plurality of pieces of data to be processed, the object data file at least including the data to be processed and storage position information of the data to be processed in the second data server, and the second data server being configured to store data with an access frequency lower than a preset frequency threshold and a degree-of-importance value smaller than a preset degree-of-importance threshold; a first storage module, configured to store at least one object data file on the second data server; and a data updating module, configured to update the data values to be processed corresponding to the keys to be processed in the first data server to position values corresponding to the storage position information.

An embodiment of this disclosure provides a storage system, at least including a first data server and a second data server, the first data server being configured to store data with an access frequency higher than or equal to a preset frequency threshold and data with a degree-of-importance value larger than or equal to a preset degree-of-importance threshold, and the second data server being configured to store data with an access frequency lower than the preset frequency threshold and a degree-of-importance value smaller than the preset degree-of-importance threshold; the first data server including a first memory and first processing circuitry such as a first processor, the second data server including a second memory and second processing circuitry such as a second processor, and the first memory and the second memory being configured to store computer-executable instructions; and the first processor and the second processor being configured to implement the method for processing data provided by embodiments of this disclosure when the computer-executable instructions are executed.

An embodiment of this disclosure provides a non-transitory computer-readable storage medium, having computer programs or computer-executable instructions stored therein, when executed by processing circuitry such as a processor, implementing the method for processing data provided by embodiments of this disclosure.

An embodiment of this disclosure provides a computer program product, including computer programs or computer-executable instructions, when executed by a processor, implementing the method for processing data provided by embodiments of this disclosure.

Embodiments of this disclosure have the following beneficial effects. After the plurality of pieces of data (or data items) to be processed are acquired from the first data server, the object data file is generated based on the plurality of pieces of data to be processed. The object data file at least includes a device identifier of the second data server configured to store the data to be processed and the storage position information of the data to be processed in the second data server. Moreover, the second data server is configured to store the data with the access frequency less than the preset frequency threshold and/or the degree-of-importance value less than the preset degree-of-importance threshold. That is, the second data server is configured to store less important data with a low access frequency. At least one object data file is stored in the second data server corresponding to the device identifier. The data values to be processed corresponding to the keys to be processed in the first data server to the position values corresponding to the storage position information. That is, the first data server stores data with a high access frequency or important data (hot data), and the keys of the unimportant data (cold data) with a low access frequency and the position values of the data values corresponding to the keys. Therefore, it can be guaranteed that the keys and the data values of the cold data can be read by the first data server, thereby ensuring the availability and data reliability. In addition, because the space occupied by the position values of the data values corresponding to the keys is far smaller than that occupied by the data values themselves, the space occupied by the cold data in the first data server can be reduced, and therefore, the storage cost can be reduced.

### BRIEF DESCRIPTION OF THE DRAWINGS

FIG. 1 is a schematic diagram of a network architecture of a storage system provided by an embodiment of this disclosure.

FIG. 2 is a schematic structural diagram of a first data server 400-1 provided by an embodiment of this disclosure.

FIG. 3A is a schematic diagram of an implementation flow of a method for processing data provided by an embodiment of this disclosure.

FIG. 3B is a schematic diagram of an implementation flow of generating an object data file provided by an embodiment of this disclosure.

FIG. 3C is a schematic diagram of an implementation flow of checking data consistency provided by an embodiment of this disclosure.

FIG. 4A is a schematic diagram of an implementation flow of on-demand data recycling provided by an embodiment of this disclosure.

FIG. 4B is a schematic diagram of an implementation flow of a total capacity and an invalid data capacity of an object data file provided by an embodiment of this disclosure.

FIG. 4C is a schematic diagram of an implementation flow of periodically recovering data provided by an embodiment of this disclosure.

FIG. 5 is a schematic diagram of an implementation flow of a data read method provided by an embodiment of this disclosure.

FIG. 6 is a schematic diagram of an implementation flow of a data write method provided by an embodiment of this disclosure.

FIG. 7 is a schematic diagram of another network structure of a distributed storage system provided by an embodiment of this disclosure.

FIG. 8 is a schematic structural diagram of a Blob file provided by an embodiment of this disclosure.

FIG. 9 is a schematic diagram of a doubly-linked cache queue provided by an embodiment of this disclosure.

FIG. 10 is a schematic diagram of an implementation flow of writing data provided by an embodiment of this disclosure.

FIG. 11 is a schematic diagram of an implementation flow of reading data provided by an embodiment of this disclosure.

### DESCRIPTION OF EMBODIMENTS

To describe objectives, technical solutions, and advantages of this disclosure, the following further describes this disclosure in detail with reference to the accompanying drawings. Embodiments described should not be construed as limitation on this disclosure. Other embodiments are within the scope of this disclosure.

In the following description, the term “some embodiments” describes subsets of all possible embodiments, but “some embodiments” may be the same subset or different subsets of all possible embodiments, and may be combined with each other without conflict.

In the following description, the involved term “first\second” is merely intended to distinguish similar objects but does not necessarily indicate a specific order of an object. “First\second” is interchangeable in terms of a particular order or sequence if permitted, so that embodiments of this disclosure described here can be implemented in a sequence in addition to the sequence shown or described here.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In embodiments of this disclosure, the term “module” or “unit” refers to a computer program that has a predetermined function or a part of the computer program and operates together with other relevant parts to achieve a predetermined objective, and may be all or partially implemented by using software, hardware (such as processing circuits or memories) or a combination thereof. Similarly, a processor (or a plurality of processors or memories) may be configured to implement one or more modules or units. In addition, each module or unit can be a part of an overall module or unit that contains the functionality of that module or unit.

Unless otherwise defined, all technical and scientific terms used in this disclosure have the same meanings as commonly understood by those skilled in the technical field. The terms used in embodiments of this disclosure are merely intended to describe embodiments of this disclosure and are not intended to limit this disclosure.

Before embodiments of this disclosure are further described, terms used in this disclosure are described below. The descriptions of the terms are provided as examples only and are not intended to limit the scope of the disclosure.
1) Rocksdb: It may correspond to a log-structured merge tree (LSM-tree) architecture engine developed based on LevelDB that provides key-value storage and read-write functions.
2) Sorted sequence table (SST) file: It may correspond to a file that stores all data in a form of key-value sorted in the order of data keys.
3) Compaction: It may correspond to a process of merging and compacting data from different layers in the LSM storage structure.
4) Raft: It may correspond to a consensus algorithm that achieves consistency of a plurality of copies of data in the distributed system.
5) Blob file: It may correspond to an object data file organized according to a specific storage structure.
6) Garbage collection (GC): It may correspond to space recycling for garbage data in the storage system.
7) Hot data: It may correspond to data with a high access frequency and critical to services and applications. The hot data may need to be accessed and processed quickly and efficiently, so it needs to be stored on high-performance, low-latency storage devices such as a solid-state disk (SSD) and an internal memory.
8) Cold data: It may correspond to data with a low access frequency and less important to services and applications. The cold data may need to be stored for a long time but does not require frequent access and processing, so it may be stored on lower-cost, higher-capacity storage devices such as tape libraries.
9) Data cooling: It may correspond to a process of separating data from the storage medium of hot data and storing it in the storage medium of cold data.
10) Serialization processing: It may correspond to the transformation of data in a specific format into a string sequence that can be recovered. In some embodiments of this disclosure, it may correspond to the transformation of the storage position information into the position values expressed by a string sequence.
11) Deserialization processing: It may correspond to a process of recovering the string sequence obtained from serialization to data in the original format. In some embodiments of this disclosure, the position value represented by the string sequence may be transformed into storage position information.

In order to better understand the method for processing data provided by embodiments of this disclosure, the methods for processing data for separating hot data from cold data are first described.

Two methods for processing data for separating the hot data from cold data are described herein as non-limiting examples.
I: Bypass cooling. The process of separating and storing data from the hot data media to the cold data media may be referred to as data cooling. In this method, a bypass cooling module is used to scan and filter the data, write the filtered cold data to a cheap cold storage medium, and delete the cold data in the expensive hot medium.
II: Use SST file of Rocksdb to cool. According to a write time feature, the data is concentrated in the same SST file as much as possible. The cold data SST file of Rocksdb is written to the cheap storage medium on a file-by-file basis.

The bypass cooling method may require additional resources to support the bypass cooling module, which will cause the cooling module to become a performance bottleneck, and this method will cause a large number of empty reads in the cold data read. The method of cooling by the SST file of Rocksdb may need to sort by data write time, and may require a unique Rocksdb Comparator policy to concentrate keys with close time in one SST file, and the cooling strategy cannot be extended. The fixed SST file format may not be suitable to handle scenarios where copies are split and merged. In the distributed storage system, the SST files of the plurality of copies are independent of each other, and the difference of the SST file in the copies will lead to inconsistency of cooled data between the copies.

Cooling files are organized by data self-aggregation, and the cold data to be cooled are screened according to the customized cooling policy during the data compaction process of Rocksdb, and the cooling policy can be extended according to user needs. The range of keys routed to the data copy and the corresponding copy ID are recorded in cooling file meta information and configured for copy meta information verification, and the cooled data of the Blob file can be automatically adjusted and sorted under copy splitting and merging. In this method, only the master copy is subjected to data cooling before the plurality of copies of data, the position information may be copied to other copies by a Raft protocol after cooling, and thus the consistency of the plurality of copies of cooling data can be kept.

Embodiments of this disclosure provide a method and apparatus for processing data, a storage system, a computer-readable storage medium, and a computer program product. The key with small storage space consumption is kept in a hot data storage cluster. The value with large storage space consumption is transferred to a cold data storage cluster. By this method, the hot data storage cluster only stores the position information of the keys and values of a small amount of data in the cold data storage cluster. In the read access process of the service, there will be no empty read, so it can accurately determine whether the data exists and what the actual content of the data is, and can also ensure the consistency of the plurality of copies of data. The following describes one or more application examples of the electronic device provided by embodiments of this disclosure. The electronic device provided by embodiments of this disclosure may be implemented as a laptop, a tablet computer, a desktop computer, a set-top box, a mobile device (for example, a mobile phone, a portable music player, a personal digital assistant, a special messaging device, and a portable game device), a smart phone, a smart speaker, a smart watch, a smart TV, an in-vehicle terminal and other types of user terminals, and may also be implemented as servers. The following describes an application example when the device is implemented as a server.

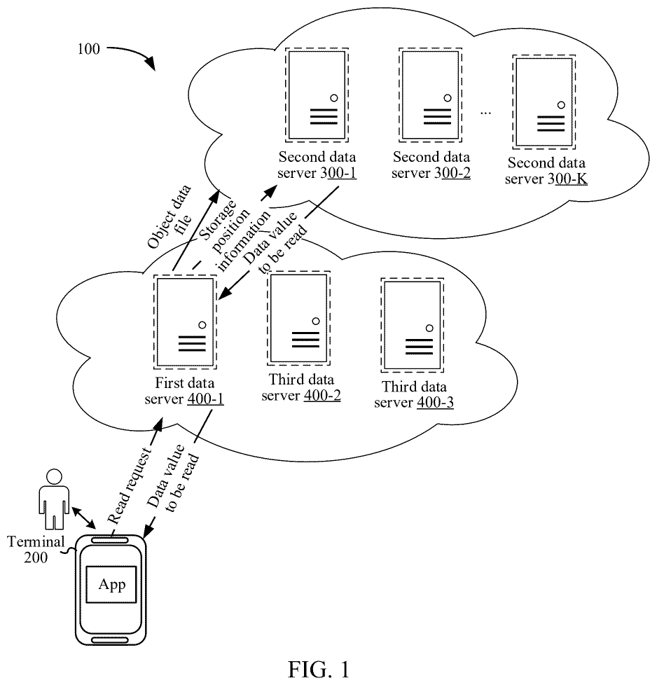

With reference to FIG. 1, FIG. 1 is a schematic architecture diagram of a distributed storage system 100 provided by an embodiment of this disclosure. As shown in FIG. 1, the system includes a terminal 200, a first data server cluster (including, for example, a first data server 400-1 serving as a master copy, a third data server 400-2 serving as a slave copy, and a third data server 400-3 serving as a slave copy), and a second data server cluster (including, for example, a second data server 300-1, a second data server 300-2, . . . , a second data server 300-K). The terminal 200 is connected with the first data server cluster by a network, and the first data server cluster is connected with the second data server cluster by a network (not shown in FIG. 1). The network may be a wide area network or a local area network, or a combination thereof.

Each server in the first data server cluster is configured to store data with an access frequency higher than or equal to a preset frequency threshold, and data with a degree-of-importance value greater than or equal to a preset degree-of-importance threshold (in some embodiments, the data may also be referred to as hot data). The second data server cluster is configured to store data with an access frequency lower than the preset frequency threshold and a degree-of-importance value smaller than the preset degree-of-importance threshold (in some embodiments, the data may also be referred to as cold data).

The first data server 400-1 acquires a plurality of pieces of data to be processed from stored data by a filter in the process of merging and compacting the data. In some embodiments of this disclosure, the data to be processed may be data with the access frequency lower than the preset frequency threshold and the degree-of-importance value smaller than the preset degree-of-importance threshold, namely cold data. The data to be processed includes keys to be processed and data values to be processed corresponding to the keys to be processed. The first data server 400-1 generates at least one object data file based on the plurality of pieces of data to be processed. The object data file at least includes a device identifier of the second data server for storing the data to be processed and storage position information of the data to be processed in the second data server. Then the first data server 400-1 stores the at least one object data file to the second data server corresponding to the device identifier based on the storage position information, and updates the data values to be processed corresponding to the keys to be processed in the first data server to position values corresponding to the storage position information. The position values are obtained by serializing the storage position information. The storage position information may be transformed by using a preset serialization processing function to obtain the position values in a character string format. In some embodiments, the first data server 400-1 transmits the storage position information to a third data server 400-2 serving as a slave copy and a third server 400-3 serving as a slave copy, so that the data values to be processed corresponding to the keys to be processed in the third data server 400-2 are updated to the position values corresponding to the storage position information, and the data values to be processed corresponding to the keys to be processed in the third data server 400-3 are updated to the position values corresponding to the storage position information, thereby realizing data consistency of the master copy and the slave copy.

In some embodiments of this disclosure, the keys of the hot data and the data values corresponding to the keys, the keys of cold data and the position information of the data values corresponding to the keys are stored in the first data server. Therefore, the storage cost of the data can be reduced on the premise of ensuring the availability and the data reliability.

When receiving a data read operation, the terminal 200 transmits a data read request to the first data server 400-1. The data read request carries keys to be read of data to be read. When it is determined that the keys to be read are stored in the first data server 400-1, attribute information of the data values corresponding to the keys to be read are acquired. When the attribute information represents that the position values corresponding to storage position information of the data values to be read in the second data server are stored in the first data server, deserialization processing is carried out on the position values to obtain the storage position information. The data values to be read are acquired from the second data server based on the storage position information, and the data values to be read are transmitted to the terminal 200. Therefore, when it is needed to read the cold data, the data values to be read can be acquired based on the storage position information of the data values of the cold data in the first data server, thus empty data read can be avoided, thereby improving the data read efficiency.

In some embodiments, the first data server, the second data server, and the third data server may be independent physical servers, may also be a server cluster or a distributed system composed of a plurality of physical servers, and may also be cloud servers providing basic cloud computing services such as cloud services, cloud databases, cloud computing, cloud functions, cloud storage, network services, cloud communication, middleware services, domain name services, security services, content delivery networks (CDN), big data, and artificial intelligence platforms. The terminal 200 may be a smart phone, a tablet computer, a notebook computer, a desktop computer, a smart speaker, a smart watch, an in-vehicle terminal and the like, but is not limited thereto. The terminal and the servers may be directly or indirectly connected in a wired or wireless communication mode, which is not limited in this disclosure.

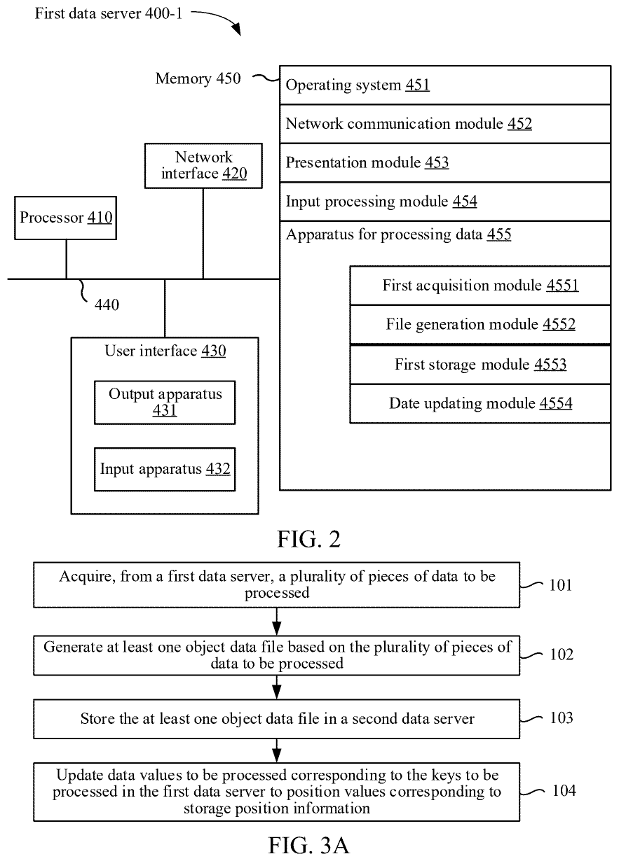

FIG. 2 is a schematic structural diagram of a first data server 400-1 provided by an embodiment of this disclosure. The first data server 400-1 shown in FIG. 2 includes processing circuitry such as at least one processor 410. The first data server 400-1 also includes a memory 450, at least one network interface 420, and a user interface 430. All the components in the first data server 400-1 are coupled together by a bus system 440. The bus system 440 is configured to implement connection and communication between these components. In addition to a data bust, the bus system 440 further includes a power bus, a control bus, and a status signal bus. However, for ease of description, all types of buses are marked as the bus system 440 in FIG. 2.

The processor 410 may be an integrated circuit chip, and has a signal processing capability, for example, a general-purpose processor, a digital signal processor (DSP), another programmable logic device, a discrete gate or transistor logic device, or a discrete hardware component. The general-purpose processor may be a microprocessor or any suitable processor.

The user interface 430 includes one or more output apparatuses 431 that enable presentation of media content, including one or more speakers and/or one or more visual display screens. The user interface 430 further includes one or more input apparatuses 432, including a user interface component helping a user input, for example, a keyboard, a mouse, a microphone, a touch display screen, a camera, or another input button and control.

The memory 450 may be a removable memory, a non-removable memory, or a combination thereof. Examples of hardware devices include a solid state memory, a hard disk drive, an optical disk drive, and the like. In some embodiments, the memory 450 includes one or more data servers that are physically away from the processor 410.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in embodiments of this disclosure is to include any suitable type of memories. In some examples, memory 450 includes a non-transitory computer-readable storage medium.

In some embodiments, the memory 450 can store data to support various operations. Examples of the data include a program, a module, and a data structure, or a subset or a superset thereof, which are described below.

An operating system 451 includes system programs for processing various basic system services and performing hardware-related tasks, for example, a framework layer, a core library layer, and a driver layer for implementing various basic services and processing hardware-based tasks.

A network communication module 452 is configured to connect to other electronic devices via one or more (wired or wireless) network interfaces 420. The network interfaces 420 include Bluetooth, Wi-Fi, universal serial bus (USB), and the like.

A presentation module 453 is configured to enable presentation of information via one or more output apparatuses 431 (for example, a display and a speaker) associated with the user interface 430 (for example, a user interface for operating a peripheral device and displaying content and information).

An input processing module 454 is configured to detect one or more user inputs or interactions from one of one or more input devices 432 and translate a detected input or interaction.

In some embodiments, the apparatus provided by embodiments of this disclosure may be implemented by software. FIG. 2 shows an apparatus for processing data 455 stored in the memory 450. The apparatus for processing data may be software in forms of programs, plug-ins and the like, and includes the following software modules: a first acquisition module 4551, a file generation module 4552, a first storage module 4553, and a data updating module 4554. The modules are logical, so that the modules may be combined in various manners or further split according to functions to be implemented. The function of each module will be described below.

In some other embodiments, the apparatus provided by embodiments of this disclosure may be implemented by hardware. As an example, the apparatus provided by embodiments of this disclosure may be a processor in a form of a hardware decoding processor, which is programmed to execute the method for processing data provided by embodiments of this disclosure. For example, the processor in the form of the hardware decoding processor may be one or more of an application specific integrated circuit (ASIC), a digital signal processor (DSP), a programmable logic device (PLD), a complex programmable logic device (CPLD), a field-programmable gate array (FPGA), or another electronic component.

The method for processing data provided by embodiments of this disclosure will be described with reference to examples of application and implementation of the servers provided by embodiments of this disclosure.

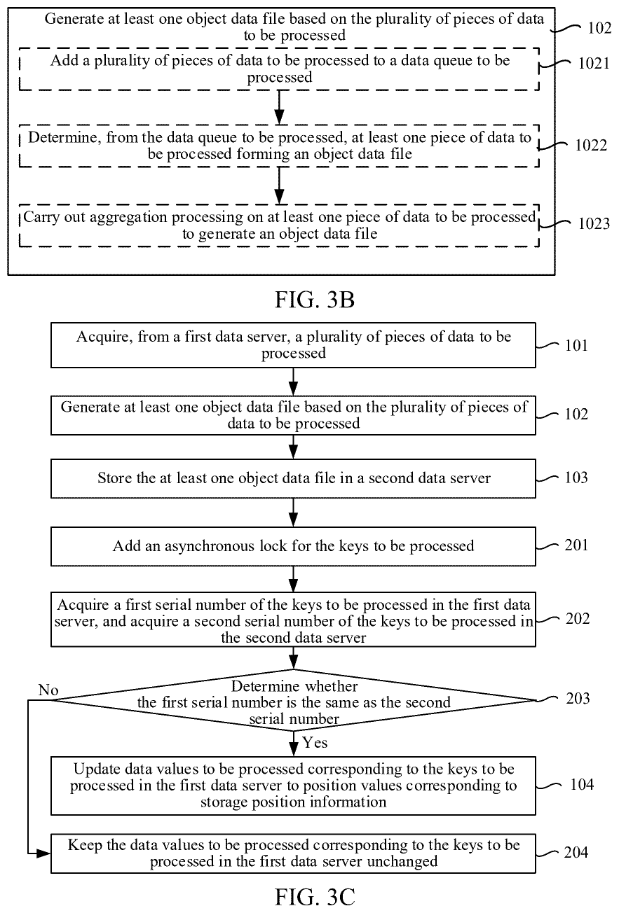

FIG. 3A is a schematic diagram of an implementation flow of a method for processing data provided by an embodiment of this disclosure, which will be illustrated with reference to operations shown in FIG. 3A, and the subject of each operation in FIG. 3A is the first data server. The first data server may be a data server that serves as a master copy in the storage system.
Operation 101: Acquire, from a first data server, a plurality of pieces of data (also referred to as data items) to be processed. For example, a plurality of data items is acquired from a first data server. The plurality of data items includes keys and data values corresponding to the keys.

The data to be processed includes keys to be processed and data values to be processed corresponding to the keys to be processed. In some embodiments, when it is determined that a data screening opportunity is reached, the first data server acquires an access frequency and a degree-of-importance value of each piece of data in the first data server. When a duration between a current moment and a moment of data processing last time reaches a preset interval duration, it is determined that the data screening opportunity is reached, or when a rest storage space of the first data server is smaller than a preset space threshold, it is determined that the data screening opportunity is reached. The access frequency of the data may be represented by the number of accessed times of the data within a preset duration. In some examples, the preset duration may be one day, seven days, ten days, and the like. The access frequency may be three times per day, five times per week, and the like. The degree-of-importance values of the data may be determined based on the data type. Degree-of-importance values corresponding to different data types may be set in advance. Then the degree-of-importance values of the data are determined based on the data type of the data. In some embodiments, the degree-of-importance values of the data may be manually set when the data is written. After acquiring the access frequency and the degree-of-importance values of each piece of data, the first data server determines data meeting a preset cooling condition as the data to be processed based on the access frequency and the degree-of-importance value of each piece of data. The preset cooling condition corresponds to a cooling strategy in other embodiments. The preset cooling condition may be set according to an actual storage requirement. For example, the preset cooling condition may be that the access frequency is smaller than the preset frequency threshold, or the degree-of-importance value is smaller than the preset degree-of-importance threshold. In some embodiments, the preset cooling condition may also be that a storage duration exceeds a preset duration threshold. In some embodiments of this disclosure, the data meeting the preset cooling condition is determined as the data to be processed, namely data to be stored in the second data server. The second data server is configured to store data with an access frequency lower than a preset frequency threshold and a degree-of-importance value smaller than a preset degree-of-importance threshold. The second data server is configured to store cold data.
Operation 102: Generate at least one object data file based on the plurality of pieces of data to be processed. For example, at least one object data file is generated, by processing circuitry, based on the plurality of data items. The at least one object data file includes the plurality of data items and storage position information of the plurality of data items in a second data server.

In some embodiments, with reference to FIG. 3B, operation 102 may be implemented by the following operations 1021 to 1023 which are specifically described below.
Operation 1021: Add the plurality of pieces of data to be processed to a data queue to be processed. For example, the plurality of data items is added to a data queue.

The data queue to be processed may be a first-in first-out multi-producer single-consumer linked cache queue. That is, the data queue to be processed stores data to be processed transmitted by a plurality of different first data servers. The data to be processed in the data queue to be processed are consumed by an aggregator. That is, the aggregator is configured to carry out aggregation processing on the data to be processed.
Operation 1022: Determine, from the data queue to be processed, at least one piece of data to be processed forming the object data file. For example, from the data queue, at least one data item is determined to be included in the at least one object data file.

In some embodiments, the size of the object data file (the size of a data storable space of the file) is preset, so in the operation, at least one piece of data to be processed forming one object data file may be determined according to the size of each piece of data to be processed (namely the size of the space occupied by the data) in the data queue to be processed. The total size of the space occupied by the at least one piece of data to be processed forming one object data file cannot be larger than the size of the data storable space of the object data file.

In some examples, if the size of the data storable space of the object data file is 3 MB, the size of the data to be processed is sequentially determined from a data queue to be processed. It is assumed that 10 pieces of data to be processed are stored in the current data queue to be processed, in which, the size of the tenth piece of data to be processed is 1 MB, the size of the ninth piece of data to be processed is 1 MB, the size of the eighth piece of data to be processed is 2 MB, and the size of the seventh piece of data to be processed is 0.5 MB. The total size of the tenth piece of data to be processed and the ninth piece of data to be processed is 2 MB, which is smaller than the size of the data storable space of the object data file of 3 MB. The total size of the tenth piece of data to be processed, the ninth piece of data to be processed, and the eighth piece of data to be processed is 4 MB, which is greater than 3 MB. Therefore, the total size of the tenth piece of data to be processed and the ninth piece of data to be processed being 2 MB is determined to the data to be processed forming the object data file.
Operation 1023: Carry out aggregation processing on at least one piece of data to be processed to generate an object data file. For example, the at least one object data file is generated based on aggregation processing of the at least one data item. In some examples, the at least one object data file includes a header area configured to store attribute information of the at least one object data file, an inode area configured to store the storage position information of the at least one data item in the second data server, a data area configured to store the data value of the at least one data item, and a footer area configured to store at least a device identifier of the second data server.

The object data file at least includes a device identifier of the second data server for storing the data to be processed and storage position information of the data to be processed in the second data server. The second data server is configured to store the data with the access frequency lower than the preset frequency threshold and the degree-of-importance value smaller than the preset degree-of-importance threshold. In some embodiments, the data to be processed of different services are stored in different second data servers. Therefore, when at least one piece of data to be processed is subjected to aggregation processing, a service identifier of the data to be processed may be acquired, and then the device identifier of the second data server for storing the data to be processed is determined based on the service identifier of the data to be processed.

In some embodiments, the at least one piece of data to be processed may be subjected to aggregation processing by an aggregator. Firstly, an aggregator instance is created and initialized. Then the at least one piece of data to be processed is transmitted to a processing module of the aggregator. The processing module of the aggregator performs data aggregation according to aggregation logic after receiving the at least one piece of data to be processed, so as to obtain the object data file.

The object data file includes a header area, an inode area, a data area, and a footer area. The header area is configured to store attribute information of the object data file. The attribute information of the object data file includes, but is not limited to: file offset magnitude of the inode area, file offset magnitude of the data area, file offset magnitude of the footer area, and CRC32 verification information of the object data file. The inode area is configured to store storage position information of the data values to be processed in the second data server and the keys to be processed. The storage information of the data values to be processed may include the data offset magnitude of the data values to be processed and the size of the occupied space of the data values to be processed. In some embodiments, the inode area is further configured to store a hash value of the keys to be processed, a second index number corresponding to the keys to be processed, and the write-in time, expiration time, and verification information of the data to be processed. The data area is configured to store the data values to be processed. The footer area is configured to store at least the device identifier of the second data server. The footer area may further store a start value and a termination value of the keys stored in the object data file and information such as the device identifier of the third data server serving as the slave copy, the file creation time, and the file size.
Operation 103: Store at least one object data file in a second data server.

In some embodiments, the data to be processed in the data queue to be processed is consumed by the aggregator. At least one generated object data file will be added to the first-in first-out multi-producer single-consumer linked cache queue, namely a cooling task queue in other embodiments. Object data files generated by aggregators in a plurality of different first data servers may be stored in the cooling task queue. The object data files in the cooling task queue may be consumed by an executor. That is, the executor stores the object data files in the cooling task queue to the second data server corresponding to the device identifier.

In some embodiments, as shown in FIG. 3C, after operation 103, data consistency may be guaranteed by the following operations 201 to 204, and it will be described with reference to FIG. 3C.
Operation 201: Add an asynchronous lock for the keys to be processed.

In some embodiments, the asynchronous lock may be added to the keys to be processed by an asynchronous lock function. After the asynchronous lock is added, another process can be operated only after one existing process is finished. In some embodiments of this disclosure, after the asynchronous lock is added to the keys to be processed, read-write operation can be performed on the data values to be processed corresponding to the keys to be processed only after operations 202 to 204 or operations 202 to 104 are executed. Thus the problem of data inconsistency caused by the change in the data values to be processed after the object data files are generated and before the data values to be processed are updated to the position values corresponding to storage position information can be avoided.
Operation 202: Acquire a first serial number of the keys to be processed in the first data server, and acquire a second serial number of the keys to be processed in the second data server.

In some embodiments of this disclosure, a first serial number corresponding to each key is stored in the first data server. The serial numbers are globally unique and are gradually increased along with a write request. When the object data file is generated based on the data to be processed, a second index number of each key to be processed is recorded in the inode area of the object data file. The second index number is acquired from the first data server when the object data file is generated. If the write operation is carried out on the data values to be processed corresponding to the keys to be processed in the process of generating the object data file, the first index number of the keys to be processed in the first data server will change. In some examples, it is assumed that the first index number corresponding to the keys to be processed acquired from the first data server is 25 in the process of generating the object data file, the second index number of the keys to be processed stored in the inode area in the generated object data file is 25. If the write operation is carried out on the data values to be processed corresponding to the keys to be processed twice in the process of generating the object data file, the first index number of the keys to be processed in the first data server is 27.
Operation 203: Determine whether the first serial number is the same as the second serial number.

When the first serial number is the same as the second serial number, it is indicated that the data values to be processed in the second data server are not outdated. Operation 104 is executed. That is, the data values to be processed corresponding to the keys to be processed in the first data server are updated to the position values corresponding to storage position information. When the first serial number is different from the second serial number, operation 204 is executed.
Operation 204: Keep the data values to be processed corresponding to the keys to be processed in the first data server unchanged.

When the first serial number is different from the second serial number, it is indicated that in the process of processing data to be processed, generating the object data file, and storing the object data file into the second data server, the data values to be processed corresponding to the keys to be processed in the first data server are changed. Because the values stored in the second data server are values before the change, namely, the values stored in the second data server are outdated, the data values to be processed corresponding to the keys to be processed in the first data server are no longer updated to the position values corresponding to storage position information, namely, the data values to be processed corresponding to the keys to be processed in the first data server are kept unchanged. Moreover, in the process of processing the data to be processed, generating the object data file, and storing the object data file into the second data server, the data values to be processed corresponding to the keys to be processed in the first data server are changed, it is indicated that the data to be processed is accessed in this period. It may be considered that the data to be processed is still hot data which may be accessed. Therefore the data to be processed are not stored into the second data server temporarily.

With reference to FIG. 3A, it will be described below following operation 103.
Operation 104: Update the data values to be processed corresponding to the keys to be processed in the first data server to the position values corresponding to the storage position information. For example, the data values corresponding to the keys of the plurality of data items in the first data server are updated, by the processing circuitry, with position values indicating the storage position information of the plurality of data items in a second data server.

In some embodiments, the storage position information of the data values to be processed includes the file name of the object data file, the data offset of the data values to be processed in the object data file, the data space size of the data values to be processed, and the verification information of the data values to be processed. The keys to be processed and the data values to be processed corresponding to the keys to be processed are originally stored in the first data server. The data values to be processed may be a character string, so the storage position information of the data values to be processed needs to be subjected to serialization processing to obtain the position values corresponding to the storage position information. The data values to be processed corresponding to the keys to be processed in the first data server are updated to the position value corresponding to the storage position information. Therefore, the key values of hot data, the keys of cold data, and the position value of the storage position information of the values of the cold data are stored in the first data server. The serialization processing refers to the transformation of the data in a specific format into a recoverable character string sequence. In some embodiments of this disclosure, the storage position information is transformed into the position value represented by the character string sequence. Therefore, the serialized character string position information can be stored in the file or a text field of a database, so that persistent storage of the data is realized; and compared with original storage position information, the character string position information can reduce the occupation of the storage space, and moreover, the readability, security, compatibility, and expansibility of the data can be improved.

In the method for processing data provided by embodiments of this disclosure, after the plurality of pieces of data to be processed which need to be cooled are acquired from the first data server, the object data file is generated based on the plurality of pieces of data to be processed. The object data file at least includes the storage position information for the data to be processed and the data values to be processed in the second data server. The second data server is configured to store the data with the access frequency lower than the preset frequency threshold and the degree-of-importance value smaller than the preset degree-of-importance threshold. That is, the second data server is configured to store unimportant data with a low access frequency. The at least one object data file is stored to the second data server. The data values to be processed corresponding to the keys to be processed in the first data server are updated to the position values corresponding to the storage position information. That is, the first data server stores the data with a high access frequency or important data (hot data), the keys of unimportant data (cold data) with a low access frequency, and the position values of the data values corresponding to the keys, so that the keys and the data values of the cold data can be read through the first data server, thereby ensuring the availability and data reliability. Moreover, the size of the space occupied by the position values of the data values corresponding to the keys is far smaller than the size of the space occupied by the data values, so the space occupied by the cold data in the first data server can be reduced, thereby reducing the storage cost. In addition, before the data values to be processed corresponding to the keys to be processed in the first data server are updated to the position values corresponding to the storage position information, the data consistency is ensured by adding the asynchronous lock to the keys to be processed and through the first serial number of the keys to be processed in the first data server and the second serial number of the keys to be processed in the second data server.

In some embodiments, the invalid data in the second data server may be spatially recovered in the following two modes. The first is on-demand recycling when a fragmentation rate of the object data file reaches a preset fragmentation rate threshold. The other is periodic inspection recycling when a preset periodic recycling period is reached. The two data recycling modes will be described below respectively.

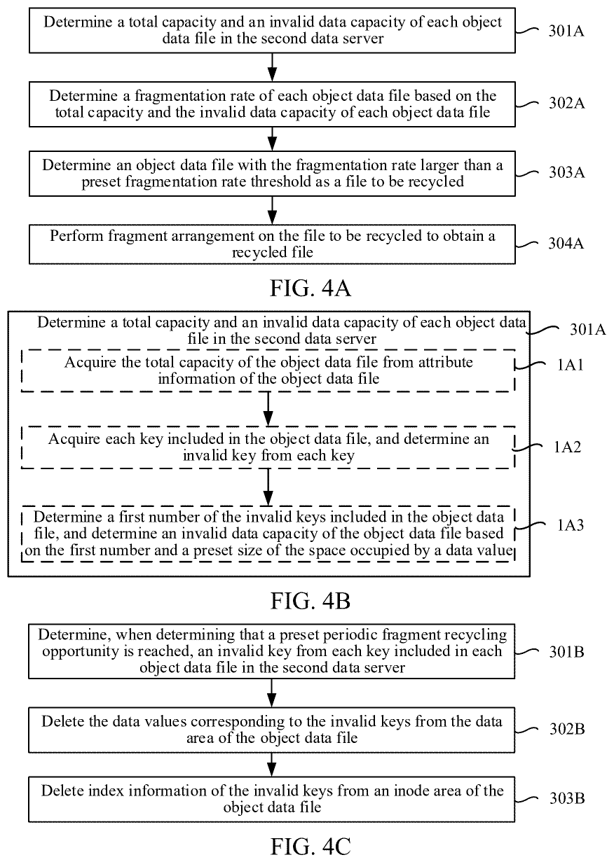

FIG. 4A is a schematic diagram of an implementation flow of on-demand data recycling provided by an embodiment of this disclosure. As shown in FIG. 4A, data recycling may be carried out on demand through operations 301A to 304A as shown in FIG. 4A. The execution body of each operation shown in FIG. 4A is the second data server, which will be specifically described below.
Operation 301A: Determine a total capacity and an invalid data capacity of each object data file in the second data server.

In some embodiments, operations 1A1 to 1A3 shown in FIG. 4B are executed on each object data file in the second data server to acquire the total capacity and the invalid data capacity of each object data file, which will be described with reference to FIG. 4B below.
Operation 1A1: Acquire the total capacity of the object data file from the attribute information of the object data file.

In some embodiments, an attribute value corresponding to the file size field may be acquired from the attribute information of the object data file, and the attribute value corresponding to the file size field is determined as the total capacity of the object data file.
Operation 1A2: Acquire each key included in the object data file, and determine an invalid key from each key.

If the storage system receives a data deletion instruction, data in the first data server is deleted, so that the keys and the data values corresponding to the keys or the position values of the data values corresponding to the keys in the first data server may be deleted, but the data deleted from the first data server may still exist in the second data server. At the moment, the data in the second data server is invalid data. Based on this, when implementing operation 1A2, the first data server is searched for each key included in an object data file firstly. If the key in the object data file does not exist in the first data server, it is indicated that the key and the data value corresponding to the key are deleted from the first data server, thus the data corresponding to the key will not be accessed any more, and the key which does not exist in the first data server is determined as an invalid key. For example, based on a first key being included in the stored object data file in the second data server and absent in the first data server, the first key is determined as one of the one or more invalid keys.

When the key included in the object data file also exists in the first data server, the attribute information of the data value corresponding to the key is acquired. When the attribute information represents that the data value corresponding to the key is stored in the first data server, read-write is performed on the data value corresponding to the key without acquiring the data value from the second data server. That is, the data value of the key stored in the second data server is outdated data, so the key is also determined as an invalid key. For example, based on a second key being included in the stored object data file in the second data server and included in the first data server, attribute information of the data value corresponding to the second key in the first data server is acquired; and, when the attribute information indicates that the data value corresponding to the second key is stored in the first data server, the second is determined as one of the one or more invalid keys.
Operation 1A3: Determine a first number of the invalid keys included in the object data file, and determine an invalid data capacity of the object data file based on the first number and a preset size of the space occupied by a data value.

In some embodiments, the size of the space occupied by the data value may be acquired from the inode area of the object data file, and the product of the first number and the size of the space occupied by the data value is determined as the invalid data capacity of the object data file.
Operation 302A: Determine a fragmentation rate of each object data file based on the total capacity and the invalid data capacity of each object data file.

In some embodiments, the invalid data capacity is divided by the total capacity to obtain the fragmentation rate of the object data file. In some examples, if the total capacity of an object data file is 10 MB and the invalid data capacity is 6 MB, the fragmentation rate of the object data file is 60%.
Operation 303A: Determine an object data file with the fragmentation rate larger than a preset fragmentation rate threshold as a file to be recycled.

In some embodiments, the fragmentation rate threshold is a real number between 0 and 1. In some examples, the fragmentation rate threshold may be 0.4, namely 40%. When the fragmentation rate of the object data file is greater than the fragmentation rate threshold, it is indicated that the object data file includes a large amount of invalid data, it is needed to carry out fragmentation recycling processing, and the object data file is determined as a file to be recycled.
Operation 304A: Perform fragment arrangement on the file to be recycled to obtain a recycled file.

In some embodiments, when implementing operation 304A, the data values corresponding to the invalid keys are deleted from the data area of the file to be recycled, and then the index information of the invalid keys is deleted from the inode area of the file to be recycled, so as to obtain a recycled file.

Each key in the inode area in the object data file corresponds to one piece of index information. The index information includes a hash value of the key, a second serial number of the key, the storage position information of the data value corresponding to the key, data write time, data expiration time, verification information, and the like.

According to operations 301A to 304A, after the fragmentation rate of each object data file is determined, fragment arrangement is carried out on the file to be recycled with the fragmentation rate greater the fragmentation rate threshold. That is, the index information of the invalid keys in the file to be recycled and the data values corresponding to the invalid keys are deleted to obtain the recycled file. Therefore, the invalid data can be cleaned in time, thereby improving the effectiveness of the data stored in the second data server. In addition, in some embodiments, after the recycled file is obtained, file verification may be carried out on the recycled file. For example, information to be verified of each data value of the data area in the recycled file may be generated according to a preset data verification algorithm. Then the information to be verified of each data value is matched with verification information of each data value in the inode area. If the information to be verified of the data value is the same as the verification information of the data value in the inode area, it is indicated that the data value passes verification. If the information to be verified of the data value is different from the verification information of the data value in the inode area, it is indicated that the data value does not pass verification. At the moment, the data value may be deleted from the data area, and the index information of the key corresponding to the data value is deleted from the inode area, thus the available space in the second data server is further improved, and the data reliability can also be improved.

FIG. 4C is a schematic diagram of an implementation flow of periodically recovering data provided by an embodiment of this disclosure. As shown in FIG. 4C, data recycling may be periodically carried out through operations 301B to 303B as shown in FIG. 4C, which will be specifically described below.
Operation 301B: Determine, when determining that a preset periodic fragment recycling opportunity is reached, an invalid key from each key included in each object data file in the second data server.

In some embodiments, a time period for fragment recycling may be preset. For example, the time period may be set to 30 days or 14 days. When implementing operation 301B, the time for performing periodic fragment recycling last time is acquired. The time for performing periodic fragment recycling this time is determined based on the time for performing periodic fragment recycling last time and a preset time period. When it is determined that the time for performing periodic fragment recycling this time is reached, it is determined that the periodic fragment recycling opportunity is reached, and the invalid key is determined from each object data file in the second data server at the moment. Firstly, the first data server is searched for each key included in each object data file. The keys which do not exist in the first data server are determined as invalid keys. When the keys included in the object data files also exist in the first data server, the attribute information of data values corresponding to the keys is acquired. When the attribute information represents that the data values corresponding to the keys are stored in the first data server, the keys are also determined as invalid keys.
Operation 302B: Delete the data values corresponding to the invalid keys from the data areas of the object data file.

In some embodiments, offset information of the data value corresponding to the invalid key in the data area may be acquired from the inode area in the object data file based on the invalid key. A storage position of the data value is determined from the data area based on the offset information. Then the data value stored in the storage position is deleted.
Operation 303B: Delete index information of the invalid key from the inode area of the object data file.

In some embodiments, because the data value corresponding to the invalid key is deleted from the data area, the index information corresponding to the invalid key in the inode area is also referred to as invalid information. At the moment, in order to further increase the effective space in the object data file, the index information of the invalid key is also deleted.

In operations 301B to 303B, when the preset periodic fragment recycling opportunity is reached, invalid key screening is carried out on each object data file in the second data server, and the data value and the index information corresponding to the invalid key are also deleted. That is, fragment recycling arrangement is carried out on all the data. Therefore, fragment recycling arrangement is also carried out on the object data files which do not reach the fragmentation rate threshold. The storage space occupied by the invalid data in all the object data files is released, thereby improving the available space of the second data server to the maximum extent. In some embodiments, after all the object data files are subjected to fragment recycling processing, the data values of the valid keys in all the object data files may also be verified, and the data which does not pass the verification is deleted. Thus, the available space of the second data server can be improved, and the reliability of the data can be ensured.

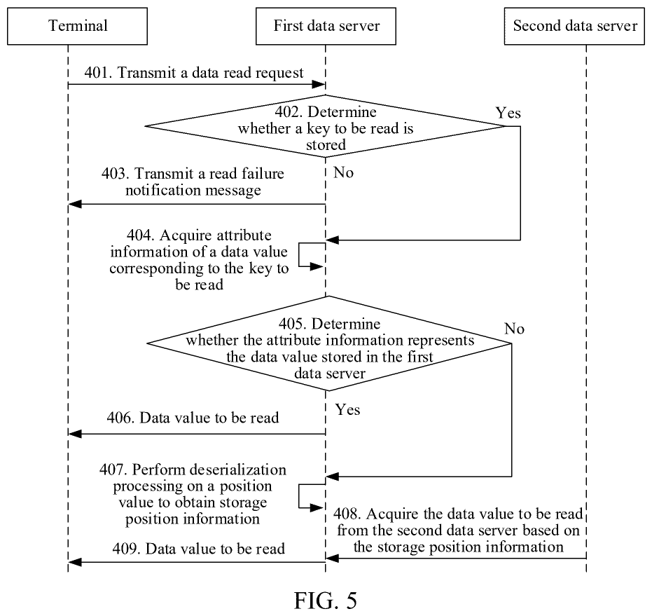

Based on the above embodiments, an aspect of this disclosure provides a data read method. FIG. 5 is a schematic diagram of an implementation flow of a data read method provided by an embodiment of this disclosure, which will be described below with reference to FIG. 5.
Operation 401: The first data server receives a data read request transmitted by a terminal.

In some embodiments, in response to a received data read operation, the terminal transmits a data read request to the first data server, the data read request carrying a key to be read of data to be read.
Operation 402: The first data server determines whether a key to be read is stored.

If no key to be read is stored in the first data server, operation 403 is executed. If a key to be read is stored in the first data server, operation 404 is executed.
Operation 403: The first data server transmits a read failure notification message to the terminal.
Operation 404: The first data server acquires attribute information of the data value corresponding to the key to be read.

In some embodiments, the attribute information of the data value corresponding to the key to be read is configured for representing the data value corresponding to the key to be read stored in the first data server, or representing the position value of the storage position information of the data value corresponding to the key to be read stored in the first data server.
Operation 405: The first data server determines whether the attribute information represents the data value stored in the first data server.

If the attribute information represents that the data value to be read is stored in the first data server, operation 406 is executed. If the attribute information represents that the data value to be read is not stored in the first data server, namely, the position value corresponding to storage position information of the data value to be read in the second data server is stored in the first data server, operation 407 is executed.
Operation 406: The first data server transmits the data value to be read to the terminal.
Operation 407: The first data server performs deserialization processing on a position value to obtain storage position information.

In some embodiments, the position value obtained by performing serialization processing on the storage position information is stored in the first data server, so in this operation, it is needed to carry out deserialization processing on the position value to obtain the storage position information.
Operation 408: The first data server acquires the data value to be read from the second data server based on the storage position information.

The storage position information includes a file identifier of the object data file, the data offset of the data values to be processed, and the size of the occupied space of the data values to be processed, thus the first data server may transmit a data acquisition request to the second data server. The data acquisition request carries the storage position information of the data value to be read. The second data server acquires the data value to be read based on the storage position information after receiving the data acquisition request and transmits the data value to be read to the first data server.
Operation 409: The first data server transmits the data value to be read to the terminal.

In the embodiment with operation 401 to operation 409, after the first data server receives the data read request, and if the data values to be read corresponding to the keys to be read carried in the data read request are stored in the first data server, the data value to be read is transmitted to the terminal. If the position values of the data values to be read corresponding to the keys to be read are stored in the first data server, the position values are firstly subjected to deserialization to obtain the storage position information. The data values to be read are acquired from the second data server based on the storage position information. The data values to be read are returned to the terminal. Therefore, after the first data server receives the data read request, no matter whether the data values to be read are locally stored or not, the data values to be read can be finally returned to the terminal, thus empty data read can be avoided, and the data read efficiency can be improved.

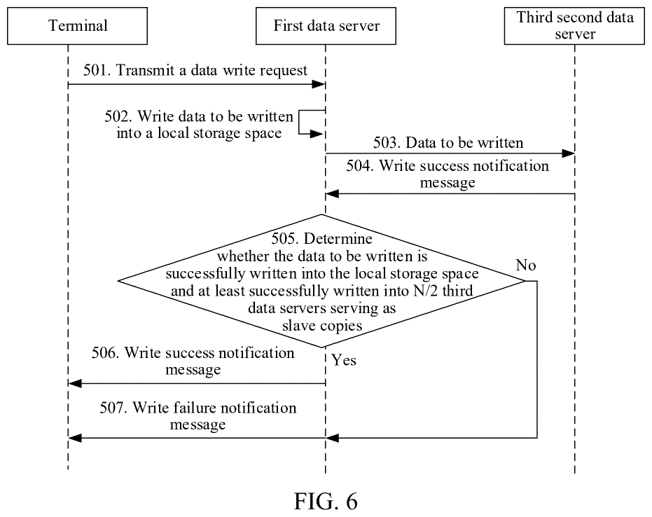

One aspect of this disclosure provides a data write method. FIG. 6 is a schematic diagram of an implementation flow of a data write method provided by an embodiment of this disclosure, which will be described below with reference to FIG. 6.
Operation 501: The first data server receives a data write request transmitted by the terminal.

The data write request carries data to be written. The data to be written includes keys to be written and data values to be written.
Operation 502: The first data server writes the data to be written into a local storage space.
Operation 503: The first data server transmits the data to be written to a third data server.

In a distributed storage system, in order to improve the disaster tolerance, the data in the first data server serving as a master copy will be backed up into at least one third data server serving as a slave copy, namely, N is a positive integer. In practical application, when implementing operation 503, the first data server transmits the data to be written to the N third data servers serving as slave copies. In order to improve the success rate of data write and the disaster tolerance, N may be an integer greater than 1. For example, N may be 2, 4, and the like. When N is 2, it is indicated that there are two third data servers serving as slave copies, and then the first data server and the two third data servers form a three-copy data service cluster.

In some embodiments, the first data server transmits the data to be written to the N third data servers serving as slave copies to instruct the third data servers to back up the data to be written to local storage spaces of the third data servers. When the third data servers successfully back up the data to be written to the local storage spaces of the third data servers, a write success notification message is transmitted to the first data server. When the third data servers fail to back up the data to be written to the local storage spaces of the third data servers, a write failure notification message is transmitted to the first data server.
Operation 504: The first data server receives the write success notification message transmitted by the third data servers.

In some embodiments, if the data to be written is successfully written into the third data servers serving as slave copies, the third data servers will transmit the write success notification message to the first data server.
Operation 505: The first data server determines whether the data to be written is successfully written into the local storage space and at least successfully written into N/2 of the N third data servers serving as slave copies.

If the data to be written is successfully written into the local storage space of the first data server and at least successfully written into the N/2 of the N third data servers serving as slave copies, it is indicated that half or more than half of the data servers successfully write the data to be written, and at the moment, operation 506 will be executed. If the data to be written is not successfully written into the local storage space or at least not successfully written into the N/2 third data servers serving as slave copies, it is indicated that no more than half of the data servers successfully write the data to be written, and at the moment, operation 507 will be executed.
Operation 506: The first data server transmits the write success notification message to the terminal.
Operation 507: The first data server transmits the write failure notification message to the terminal.

In the embodiments with operation 501 to operation 507, after receiving the data write request, the first data server writes the data to be written into the local storage space and transmits the data to be written to the plurality of third data servers serving as slave copies, it is determined that the data is successfully written only under the condition that the data to be written is successfully written into the local storage space of the first data server and at least successfully written into the N/2 of the N third data servers serving as slave copies, and the write success notification message will be transmitted to the terminal. Therefore, it can be guaranteed that the data is stored in the storage system in a multi-copy mode, thereby improving the disaster tolerance of the storage system.

Embodiments of this disclosure in a practical application scenario will be described below.

The method for processing data provided by embodiments of this disclosure can be applied to a data storage platform. For example, the method for processing data may be applied to a multi-modal, multi-tenant, and storage-computation separation supporting database, and cold-hot screening and storage separation can be carried out on data by the method for processing data provided by embodiments of this disclosure, so that the storage cost is saved, and the resource utilization is maximized.

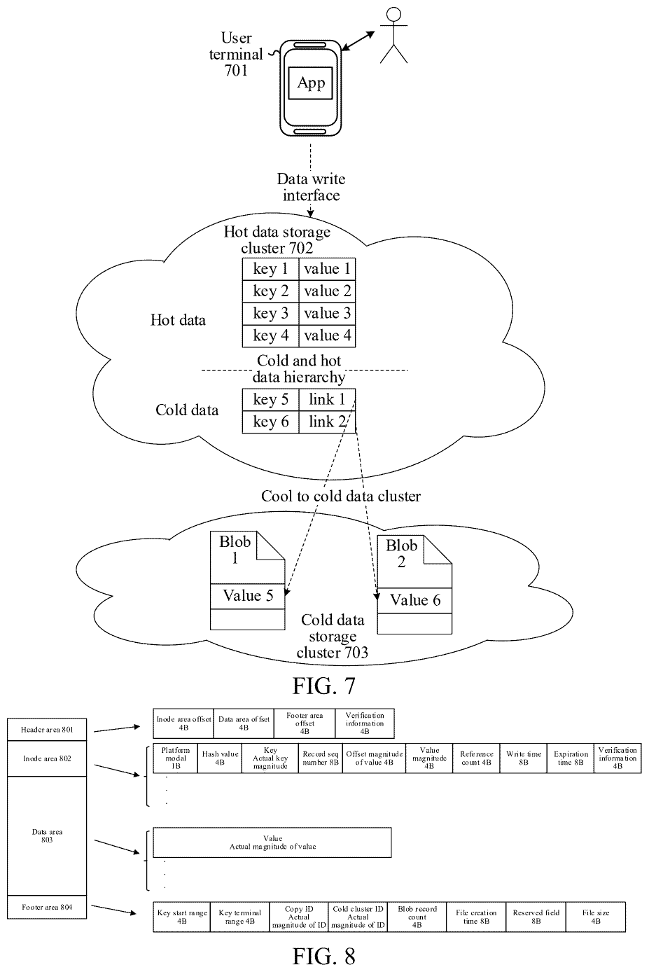

FIG. 7 is a schematic diagram of another network structure of a distributed storage system provided by an embodiment of this disclosure. As shown in FIG. 7, a user terminal 701 writes data into the distributed storage system by a data write interface, and does not perceives the layered storage form of the cold data and hot data directly. The distributed storage system keeps the key and the data values of the hot data in a hot data storage cluster 702. A Blob file (corresponding to the object data file in other embodiments) is generated based on the data value of the cold data and is stored in a cold data storage cluster 703. The keys of the cold data and the position information of the keys pointing to the cold data cluster are kept in the hot data storage cluster 702. The position information includes a Blob file name, the data offset and the data size of the data values in the Blob file, and the verification information of the data values.

FIG. 8 is a schematic structural diagram of a Blob file provided by an embodiment of this disclosure. As shown in FIG. 8, the Blob file includes four parts, namely a Header area 801, an Inode area 802, a Data area 803, and a Footer area 804.

The Header area 801 of the Blob file is configured to store the attribute information of the Blob file, and 16 Bytes are occupied in total. The attribute information includes the file offset magnitude of the inode area, the file offset magnitude of the data area, the file offset magnitude of the Footer area, and CRC32 verification information of the Blob file.

The inode area 802 of the Blob file is configured to store meta information data of each data value which is cooled to the Blob file, including the hash value of the key, the offset position of the data value, the magnitude of the data value, the timestamp, the CRC32 verification information of the data value, and the like.

The data area 803 of the Blob file is configured to store actual data of each data value which is cooled to the Blob file.

The Footer area 804 of the Blob file is configured to store logic description information of the Blob file in the storage system, such as an ID of a related copy, a hash range of the keys stored in the copy, a cluster ID of the cold data cluster.

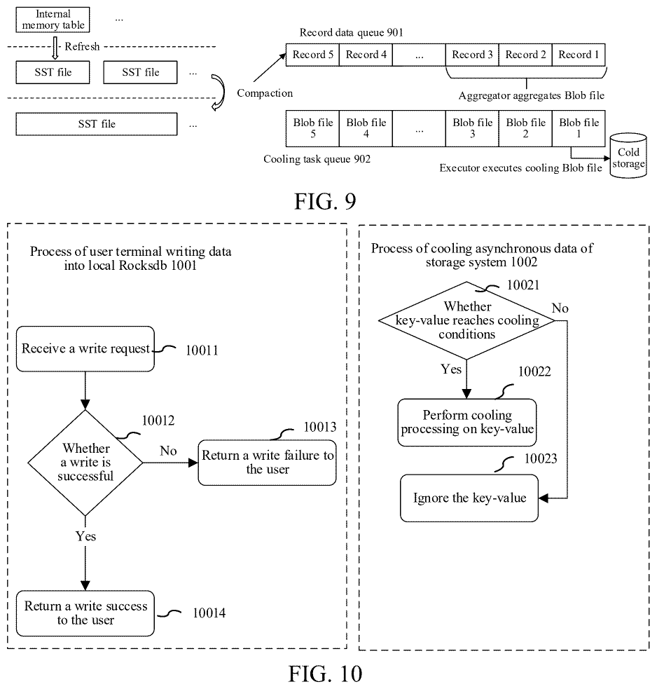

In the method for processing data provided by embodiments of this disclosure, a task model of a doubly-linked cache queue is adopted for data separation. FIG. 9 is a schematic diagram of a doubly-linked cache queue provided by an embodiment of this disclosure. As shown in FIG. 9, two first-in first-out multi-producer single-consumer linked cache queues, namely a record data queue 901 and a cooling task queue 902, are used in the task model. The record data queue 901 is used as a data primary screening cache. In a Rocksdb compaction process, a filter is configured to screen out cold data meeting a cooling strategy condition, and the cold data is stored in the record data queue 901. Then, the aggregator consumes the data cached in the record data queue, and forms a Blob file of a specific data structure. Then, the Blob file is stored in the cooling task queue 902. The cooling Blob file is generated by the aggregator and is written into the cold data cluster by an executor.

In the application process of the method for processing data provided by embodiments of this disclosure, the LSM tree size of Rocksdb and the cycle time of executing data compaction may be adjusted in combination with the service characteristics so as to control the frequency of cooling data screening.

In the method for processing data provided by embodiments of this disclosure, space recycling is carried out on garbage data in the cold data cluster, and a dual garbage recycling mechanism is provided, namely on-demand recycling and periodic inspection recycling. The storage system determines the fragmentation rate condition of the Blob file by recording the effective capacity and the total capacity of the Blob file. The total capacity is the total size of the data area when the Blob file is cooled to the cold cluster, and the effective capacity of the Blob decreases along with deletion of service data. The fragmentation rate of the Blob file can be determined through the total capacity and the effective capacity of the Blob file. The on-demand recycling mechanism sets a specific recycling threshold, and when the fragmentation rate reaches the recycling threshold, fragmentation recycling and file verification are carried out on the Blob file. The periodic inspection recycling mechanism may periodically carry out full-amount inspection on the Blob file, periodically recover a fragmented file, carry out file verification, and timely correct the capacity information.

In some embodiments of this disclosure, after data cooling, a process of replacing the data value information of the cold data with cold cluster position information is referred to as cooling write-back. In the cooling write-back process, it is needed to ensure the consistency of the plurality of copies of data. The position information of a data value is copied from the master copy to other slave copies through the Raft copy. In the write-back process, if the key is subjected to service overwriting to cause change in the data value corresponding to the key, the data value corresponding to the position information is different from the latest data value, resulting in the problem of outdated data. At the moment, it is needed to carry out consistency verification on the data. In some embodiments of this disclosure, the verification on the data consistency may be implemented by the following two operations:
I: Utilize the asynchronous lock to ensure the atomicity of the write-back process.

In some embodiments of this disclosure, the storage system routes the write operation of the same key to the same thread according to the hash value of the key. After the data is cooled to the cold data cluster, the storage system locks the cooled key by the asynchronous lock to prevent the key from conflicting.
II: Add a data serial number to prevent overwriting of the outdated data by verifying a version number.

In some embodiments of this disclosure, a sequence (seq) number of data is filled in the inode area of each piece of cooled record data, and the sequence number of the data is globally unique in the copy and gradually increases along with the write request. In the cooling write-back process, the serial number of the locally stored record data and the serial number of the record data in the cooling inode area are acquired and compared, and if the two serial numbers are the same, it is indicated that the rewritten position information is not outdated, and the position information of the data value is written into the hot data storage cluster at the moment. If the two serial numbers are different, it is indicated that the rewritten position information is outdated, the outdated position information will be discarded at the moment, and the data garbage generated by the outdated position information in the cold storage cluster is recycled by a garbage collection mechanism.

FIG. 10 is a schematic diagram of an implementation flow of writing data provided by an embodiment of this disclosure. As shown in FIG. 10, the data write process is divided into two parts: one part is a process 1001 of writing the data into the local Rosksdb by the user terminal. The other part is an asynchronous data cooling process 1002 of the storage system, and the cooling process is transparent and invisible to a user.

The process 1001 of writing the data into the local Rosksdb by the user terminal includes the following operations:
10011: Receive a write request.

The write request carries key-value information and is configured for requesting to execute the write operation to the data server serving as the master copy in the storage system.
10012: Determine whether the write operation is successful.

In some embodiments of this disclosure, the data server serving as the master copy copies the data information to two other data servers serving as the slave copies through the Raft protocol and implements in a local Rosksdb storage engine of the data server. If Raft does not achieve a quorum in the copy process or the write operation on the local Rosksdb engine fails, the write operation is determined to be failed, and then operation 10013 is executed. If Raft achieves a quorum in the copy process or the write operation on the local Rosksdb engine is successful, the write operation is determined to be successful, and then operation 10014 is executed.
10013: Return a write failure to the user.
10014: Return a write success to the user.

The asynchronous data cooling process includes the following operations:
10021: Determine whether the key-value reaches a cooling condition.

In some embodiments, in the execution process of data compaction, the Rosksdb in the data server serving as the master copy screens the key-value by the filter to determine whether the key-value reaches the cooling condition. If the key-value does not reach the cooling condition, the operation 10023 is executed. If the key-value reaches the cooling condition, operation 10022 is executed.
10022: Perform cooling processing on the key-value.

In some embodiments, the key-value may be added into the record data queue, and the cooling process is executed by the task model of the doubly-linked cache queue shown in FIG. 8.
10023: Ignore the key-value.

The key-value is ignored. That is, the cooling processing is not performed on the key-value.

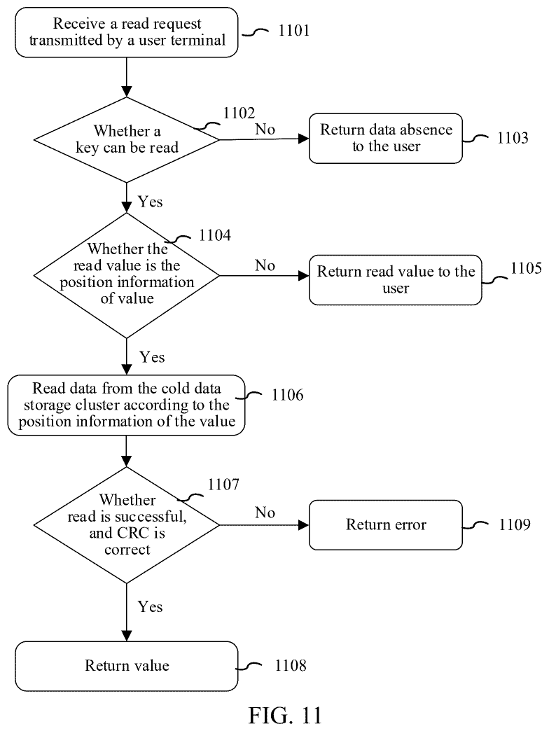

FIG. 11 is a schematic diagram of an implementation flow of reading data provided by an embodiment of this disclosure. As shown in FIG. 11, the data read process includes the following operations:
1101: Receive a read request transmitted by a user terminal.

In some embodiments, in response to a received read operation, the user terminal initiates a read request to a storage system. The read request carries the key of the data to be read.
1102: Determine whether the key can be read.

The storage system firstly determines a hash value of the key, routes the hash value to a corresponding worker thread to read the local Rosksdb, determines whether the key can be read, enters operation 1103 if the key cannot be read, and enters operation 1104 if the key is read.
1103: Return data absence to the user.
1104: Determine whether the read data value is position information of the data value.

In some embodiments, the attribute information of the read data value is acquired, and if the attribute information represents that the data value is position information, operation 1106 is executed; and if the attribute information represents that the data value is an original data value, namely the attribute information represents that the data value is not the position information of the data value, operation 1105 is executed.
1105: Return the read data value to the user.
1106: Read data from the cold data storage cluster according to the position information of the data value.

In some embodiments, the position information of the data value may be subjected to deserialization. The ID of the cold storage cluster storing the data value, the name of the Blob file with the data value, and the offset and magnitude of the data value of the key in the Blob file are acquired.
1107: Determine whether the read is successful and the CRC is correct.

In some embodiments, data is read from the cold storage cluster based on the ID of the cold storage cluster storing the data value, the name of the Blob file with the data value, and the offset and magnitude of the data value of the key in the Blob file, and whether the read is successful and CRC is correct is judged. If the read is successful and the CRC is correct, operation 1108 is executed. If read is failed or the CRC is wrong, operation 1109 is executed.
1108: Return the data value.
1109: Return a read error.

In some embodiments of this disclosure, the cold data to be cooled is screened according to the self-defined cooling strategy in the data compaction process of Rosksdb. Therefore the cooling strategy can be extended according to user requirements, and the flexibility of cooling data is improved. The range of keys routed to the data copy and the corresponding copy ID are recorded in cooling file meta information and configured for copy meta information verification, and the cooled data of the Blob file can be automatically adjusted and sorted under copy splitting and merging. In addition, only the master copy is subjected to data cooling before the plurality of copies of data, the position information may be copied to other copies by a Raft protocol after cooling, and thus the consistency of the plurality of copies of cooling data can be kept. In the method for processing data provided by embodiments of this disclosure, the keys of the cold data with low storage space consumption are kept in the hot memory, and the data values of the cold data with high storage space consumption are transferred into the cold storage cluster, so that only the keys with a small data volume and position information of the data values in the cold data storage cluster are stored in the hot data storage cluster. The storage cost of the data can be reduced under the condition that the usability and the data reliability are not influenced. In the read access process of the service, there will be no empty read, and thus the data read efficiency is improved.

The following continues to describe a structure example in which the apparatus for processing data 455 provided by embodiments of this disclosure is implemented as a software module. In some embodiments, as shown in FIG. 2, the software module in the apparatus for processing data 455 stored in the memory 450 may include: a first acquisition module 4551, configured to acquire, from a first data server, a plurality of pieces of data to be processed, the data to be processed including keys to be processed and data values to be processed corresponding to the keys to be processed; a file generation module 4552, configured to generate at least one object data file based on the plurality of pieces of data to be processed, the object data file at least including the data to be processed and storage position information of the data to be processed in the second data server, and the second data server being configured to store data with an access frequency lower than a preset frequency threshold and a degree-of-importance value smaller than a preset degree-of-importance threshold; a first storage module 4553, configured to store the at least one object data file to the second data server; and a data updating module 4554, configured to update the data values to be processed corresponding to the keys to be processed in the first data server to position values corresponding to the storage position information.

In some embodiments, the file generation module 4552 is further configured to: add the plurality of pieces of data to be processed to a data queue to be processed; determine, from the data queue to be processed, at least one piece of data to be processed forming the object data file; and carry out aggregation processing on at least one piece of data to be processed to generate the object data file, the object data file including a header area, an inode area, a data area, and a footer area, the header area being configured to store attribute information of the object data file, the inode area being configured to store the storage position information of the data values to be processed in the second data server, the data area being configured to store the data values to be processed, and the footer area being configured to store at least a device identifier of the second data server.

In some embodiments, the apparatus further includes: an asynchronous lock module, configured to add an asynchronous lock for the keys to be processed; a second acquisition module, configured to acquire a first serial number of the keys to be processed in the first data server, and acquire a second serial number of the keys to be processed in the second data server; and a serial number determination module, configured to determine whether the first serial number is the same as the second serial number, and when the first serial number is the same as the second serial number, update the data values to be processed corresponding to the keys to be processed in the first data server to the position values corresponding to storage position information.

In some embodiments, the apparatus further includes: a first determination module, configured to acquire a total capacity and an invalid data capacity of each object data file in the second data server; a second determination module, configured to determine a fragmentation rate of each object data file based on the total capacity and the invalid data capacity of each object data file; a third determination module, configured to determine an object data file with the fragmentation rate larger than a preset fragmentation rate threshold as a file to be recycled; and a fragment arrangement module, configured to perform fragment arrangement on the file to be recycled to obtain a recycled file.

In some embodiments, the first determination module is also configured to: perform the following operations on each object data file in the second data server: acquiring the total capacity of the object data file from the attribute information of the object data file; acquiring each key included in the object data file, and determine an invalid key from each key; and determining a first number of the invalid keys included in the object data file, and determining an invalid data capacity of the object data file based on the first number and a preset size of the space occupied by the data value.

In some embodiments, the first determination module is also configured to: search the first data server for each key included in the object data file, the keys which do not exist in the first data server being determined as invalid keys; acquire, when the keys included in the object data files also exist in the first data server, the attribute information of data values corresponding to the keys; and determine, when the attribute information represents that the data values corresponding to the keys are stored in the first data server, the keys as the invalid keys.

In some embodiments, the fragment arrangement module is also configured to: delete the data values corresponding to the invalid keys from the data area of the file to be recycled; and delete index information of the invalid keys from the inode area of the file to be recycled, so as to obtain the recycled file.

In some embodiments, the apparatus further includes: a third acquisition module, configured to acquire, when determining that a preset periodic fragment recycling opportunity is reached, each key included in the object data file, and determine an invalid key from each key; a data value deletion module, configured to delete the data values corresponding to the invalid keys from the data area of the object data file; and an index deletion module, configured to delete index information of the invalid keys from the inode area of the object data file.

In some embodiments, the apparatus further includes: a first receiving module, configured to receive a data read request transmitted by a terminal, the data read request carrying a key to be read of data to be read; a fourth acquisition module, configured to acquire, when the key to be read is stored in the first data server, attribute information of a data value corresponding to the key to be read; a deserialization module, configured to carry out, when the attribute information represents that a position value corresponding to storage position information of the data value to be read in the second data server is stored in the first data server, deserialization processing on the position values to obtain the storage position information; a fifth acquisition module, configured to acquire the data value to be read from the second data server based on the storage position information; and a first transmission module, configured to transmit the data value to be read to the terminal.

In some embodiments, the apparatus further includes: a second transmission module, configured to transmit, when the attribute information represents that the data value to be read is stored in the first data server, the data value to be read to the terminal.

In some embodiments, the apparatus further includes: a second receiving module, configured to receive a data write request transmitted by a terminal, the data write request carrying data to be written; a data write module, configured to write the data to be written into the first data server, and copy the data to be written into N third data servers serving as the slave copies, N being a positive integer; and a third transmission module, configured to transmit a write success notification message to the terminal when determining that the data to be written is successfully written into the first data server and is at least successfully written into N/2 third data servers serving as the slave copies.

An embodiment of this disclosure provides a computer program product. The computer program product includes a computer program or a computer-executable instruction. The computer program or the computer-executable instruction is stored in a computer-readable storage medium. The processor of the electronic device reads the computer-executable instructions from the computer-readable storage medium, and the processor executes the computer-executable instructions, causing the electronic device to execute the method for processing data provided by embodiments of this disclosure.

One aspect of this disclosure provides a computer-readable storage medium having computer-executable instructions stored therein, in which, computer-executable instructions or computer programs are stored, and the computer-executable instructions or the computer programs, when executed by the processor, cause the processor to execute the method for processing data provided by embodiments of this disclosure, for example, the method for processing data shown in FIG. 3A.

In some embodiments, the computer-readable storage medium may be a RAM, a ROM, a flash memory, a magnetic surface memory, an optical disc, or a CD-ROM, or may also be any device including one of or any combination of the above memories.

In some embodiments, the computer-executable instructions may be written in any form of programming language (including compiled or interpreted languages, or declarative or procedural languages) in the form of programs, software, software modules, scripts or code, and may be deployed in any form, including as an independent program or as a module, component, subroutine, or another unit suitable for use in a computing environment.

As an example, the computer-executable instructions may, but does not necessarily, correspond to a file in a file system, and may be stored as part of a file that stores other programs or data, for example, in one or more scripts in a hyper text markup language (HTML) document, in a single file dedicated to the program in question, or, in a plurality of collaborative files (e.g., files for storing one or more modules, subroutine or code section).

As an example, the computer-executable instructions may be deployed to be executed on a single electronic device, or on a plurality of electronic devices located in one location, or, on a plurality of electronic devices distributed in a plurality of locations and interconnected by a communication network.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

In conclusion, through embodiments of this disclosure, in the first data server configured to store the hot data, the cold data and the hot data are stored in layers. That is, in the first data server, the key-value of the hot data is stored, as well as the keys of the cold data and the position value of the storage position information of the data values stored in the second data server, so as not only to reduce the storage cost under the premise of ensuring availability and data reliability, but also to avoid empty service read when reading data, so as to improve the data reading efficiency.

The above is only some embodiments of this disclosure and are not intended to limit the scope of this disclosure. Any modifications, equivalent substitutions, and improvements made within the spirit and scope of this disclosure are included in the scope of this disclosure.

What is claimed is:

1. A method for processing data, comprising:
acquiring, from a first data server, a plurality of data items, the plurality of data items including keys and data values corresponding to the keys;
generating, by processing circuitry, at least one object data file based on the plurality of data items, the at least one object data file including the plurality of data items and storage position information of the plurality of data items in a second data server, the second data server being configured to store data with an access frequency less than a preset frequency threshold and a degree-of-importance value less than a preset degree-of-importance threshold;
storing the at least one object data file on the second data server; and
updating, by the processing circuitry, the data values corresponding to the keys of the plurality of data items in the first data server with position values indicating the storage position information of the plurality of data items in a second data server.

2. The method according to claim 1, wherein the generating the at least one object data file comprises:
adding the plurality of data items to a data queue;
determining, from the data queue, at least one data item to be included in the at least one object data file; and
generating the at least one object data file based on aggregation processing of the at least one data item, the at least one object data file including:
a header area configured to store attribute information of the at least one object data file,
an inode area configured to store the storage position information of the at least one data item in the second data server,
a data area configured to store the data value of the at least one data item, and
a footer area configured to store at least a device identifier of the second data server.

3. The method according to claim 1, wherein
the method further comprises:
adding an asynchronous lock for the keys of the plurality of data items;
acquiring a first serial number of the keys in the first data server; and
acquiring a second serial number of the keys in the second data server, and
the updating the data values is performed based on the first serial number being same as the second serial number.

4. The method according to claim 2, further comprising:
determining a total capacity and an invalid data capacity of each one of one or more stored object data files in the second data server;
determining a fragmentation rate of each one of one or more stored object data files based on the respective total capacity and the respective invalid data capacity;
determining one of the one or more stored object data files with the fragmentation rate greater than a preset fragmentation rate threshold as a target file; and
performing fragment arrangement on the target file to obtain a processed file.

5. The method according to claim 4, wherein the determining the total capacity and the invalid data capacity of each one of one or more stored object data files in the second data server comprises, for each one of one or more stored object data files:
acquiring the total capacity of the stored object data file from the attribute information of the stored object data file;
determining one or more invalid keys from one or more keys included in the stored object data file;
determining a first number of the one or more invalid keys included in the stored object data file; and
determining the invalid data capacity of the stored object data file based on the first number and a preset data value size.

6. The method according to claim 5, wherein, for each one of one or more stored object data files, the determining the one or more invalid keys comprises:
searching the first data server for each key included in the stored object data file;
based on a first key being included in the stored object data file in the second data server and absent in the first data server, determining the first key as one of the one or more invalid keys; and
based on a second key being included in the stored object data file in the second data server and included in the first data server,
acquiring attribute information of the data value corresponding to the second key in the first data server; and
determining, when the attribute information indicates that the data value corresponding to the second key is stored in the first data server, the second as one of the one or more invalid keys.

7. The method according to claim 5, wherein the performing fragment arrangement on the target file comprises:
deleting one or more data values corresponding to the one or more invalid keys from the data area of the target file; and
deleting index information of the one or more invalid keys from the inode area of the target file.

8. The method according to claim 2, further comprising, for each one of the at least one object data file in the second data server based on occurrence of a preset periodic fragment recycling opportunity:
determining one or more invalid keys from one or more keys included in the object data file;
deleting the data values corresponding to the one or more invalid keys from the data area of the object data file; and
deleting index information of the one or more invalid keys from the inode area of the object data file.

9. The method according to claim 1, further comprising:
receiving a data read request from a terminal, the data read request carrying a key to be read of data to be read;
acquiring, when the key to be read is stored in the first data server, attribute information of a data value corresponding to the key to be read;
carrying out, when the attribute information indicates that a position value corresponding to storage position information of the data value to be read in the second data server is stored in the first data server in association with the key to be read, deserialization processing on the position value to obtain the storage position information;
acquiring the data value to be read from the second data server based on the storage position information; and
transmitting the data value to be read to the terminal.

10. The method according to claim 9, further comprising:
transmitting, when the attribute information indicates that the data value to be read is stored in the first data server in association with the key to be read, the data value to be read to the terminal.

11. The method according to claim 1, further comprising:
receiving a data write request from a terminal, the data write request carrying data to be written;
writing the data to be written into the first data server;
copying the data to be written into N third data servers serving as slave copies, N being a positive integer; and
transmitting a write success notification message to the terminal based on the data to be written being successfully written into the first data server and at least N/2 of the N third data servers.

12. A data processing apparatus, comprising:
processing circuitry configured to:
acquire, from a first data server, a plurality of data items, the plurality of data items including keys and data values corresponding to the keys;
generate at least one object data file based on the plurality of data items, the at least one object data file including the plurality of data items and storage position information of the plurality of data items in a second data server, the second data server being configured to store data with an access frequency less than a preset frequency threshold and a degree-of-importance value less than a preset degree-of-importance threshold;
store the at least one object data file on the second data server; and
update the data values corresponding to the keys of the plurality of data items in the first data server with position values indicating the storage position information of the plurality of data items in a second data server.

13. The data processing apparatus according to claim 12, wherein the processing circuitry is configured to:
add the plurality of data items to a data queue;
determine, from the data queue, at least one data item to be included in the at least one object data file; and
generate the at least one object data file based on aggregation processing of the at least one data item, the at least one object data file including:
a header area configured to store attribute information of the at least one object data file,
an inode area configured to store the storage position information of the at least one data item in the second data server,
a data area configured to store the data value of the at least one data item, and
a footer area configured to store at least a device identifier of the second data server.

14. The data processing apparatus according to claim 12, wherein
the processing circuitry is configured to:
add an asynchronous lock for the keys of the plurality of data items;
acquire a first serial number of the keys in the first data server;
acquire a second serial number of the keys in the second data server; and
update the data values with the position values based on the first serial number being same as the second serial number.

15. The data processing apparatus according to claim 13, wherein the processing circuitry is configured to:
determine a total capacity and an invalid data capacity of each one of one or more stored object data files in the second data server;
determine a fragmentation rate of each one of one or more stored object data files based on the respective total capacity and the respective invalid data capacity;
determine one of the one or more stored object data files with the fragmentation rate greater than a preset fragmentation rate threshold as a target file; and
perform fragment arrangement on the target file to obtain a processed file.

16. The data processing apparatus according to claim 15, wherein the processing circuitry is configured to, for each one of one or more stored object data files:
acquire the total capacity of the stored object data file from the attribute information of the stored object data file;
determine one or more invalid keys from one or more keys included in the stored object data file;
determine a first number of the one or more invalid keys included in the stored object data file; and
determine the invalid data capacity of the stored object data file based on the first number and a preset data value size.

17. The data processing apparatus according to claim 16, wherein the processing circuitry is configured to, for each one of one or more stored object data files:
search the first data server for each key included in the stored object data file;
based on a first key being included in the stored object data file in the second data server and absent in the first data server, determine the first key as one of the one or more invalid keys; and
based on a second key being included in the stored object data file in the second data server and included in the first data server,
acquire attribute information of the data value corresponding to the second key in the first data server; and
determine, when the attribute information indicates that the data value corresponding to the second key is stored in the first data server, the second as one of the one or more invalid keys.

18. The data processing apparatus according to claim 16, wherein the processing circuitry is configured to:
delete one or more data values corresponding to the one or more invalid keys from the data area of the target file; and
delete index information of the one or more invalid keys from the inode area of the target file.

19. The data processing apparatus according to claim 13, wherein the processing circuitry is configured to, for each one of the at least one object data file in the second data server based on occurrence of a preset periodic fragment recycling opportunity:
determine one or more invalid keys from one or more keys included in the object data file;
delete the data values corresponding to the one or more invalid keys from the data area of the object data file; and
delete index information of the one or more invalid keys from the inode area of the object data file.

20. A non-transitory computer-readable storage medium storing instructions, which when executed by a processor, cause the processor to perform:
acquiring, from a first data server, a plurality of data items, the plurality of data items including keys and data values corresponding to the keys;
generating at least one object data file based on the plurality of data items, the at least one object data file including the plurality of data items and storage position information of the plurality of data items in a second data server, the second data server being configured to store data with an access frequency less than a preset frequency threshold and a degree-of-importance value less than a preset degree-of-importance threshold;
storing the at least one object data file on the second data server; and
updating the data values corresponding to the keys of the plurality of data items in the first data server with position values indicating the storage position information of the plurality of data items in a second data server.
